(19) United States
(12) Patent Application Publication
(10) Pub. No.: US 2019/0200625 A1
(43) Pub. Date: Jul. 4, 2019

(54) METHOD FOR FORMING A LAMINATED PASTRY

(71) Applicant: NESTEC S.A., Vevey (CH)

(72) Inventors: Cecile Gehin-Delval, Les Hopitaux Neufs (FR); Helen Chisholm, Cheseaux (CH); Wookyung Chung, Reminderville, OH (US); Helene Deyber, Jougne (FR); Mathieu Julien Destribats, Belmont-sur-Lausanne (CH); Zeynel Deniz Gunes, Lausanne (CH); Cindy Pelloux, Thonon-les-Bains (FR)

(21) Appl. No.: 16/327,912

(22) PCT Filed: Aug. 23, 2017
(86) PCT No.: PCT/EP2017/071203

§ 371 Date: Feb. 25, 2019

(30) Foreign Application Priority Data
Sep. 1, 2016 (EP) 16186767.6

(51) Int. Cl. A21D 13/068; A21D 2/16; A21D 13/16

(52) U.S. Cl. CPC A21D 13/068; C11B 15/00; A21D 13/16; A21D 2/16

(57) ABSTRACT

The present invention relates generally to the field of pastry. One aspect of the invention provides a method for forming a laminated pastry wherein a lipid foam is laminated between layers of dough. The invention also provides a laminated pastry having a reduced level of saturated fatty acids.

### FIELD OF THE INVENTION

The present invention relates generally to the field of pastry. One aspect of the invention provides a method for forming a laminated pastry wherein a lipid foam is laminated between layers of dough. The invention also provides a laminated pastry having a reduced level of saturated fatty acids.

### BACKGROUND OF THE INVENTION

Laminated pastries have been manufactured since at least the Middle Ages. Laminated pastries such as puff pastry are constructed of large, extended, thin sheets of dough, the dough being coated and separated by fat [McGee on Food and Cooking, Hodder & Stoughton (2004)]. The layers of the laminated pastry typically expand when cooked, leaving large air pockets inside. Laminated pastries require fats that are solid but malleable at cool room temperature such as butter, lard and vegetable shortenings. These fats are relatively high in saturated fats. Since high consumption of saturated fatty acids (SFA) has been associated with increased risk of cardiovascular diseases, authorities and consumers require SFA reduction in food products. Fats with reduced SFA content typically have a reduced viscosity and melting point. Replacing butter, lard or shortenings in laminated pastries with lower SFA (and therefore softer) vegetable fats is unsatisfactory. The softer fats do not survive the process of lamination and do not maintain the required separation of the layers. In many cases, the soft fat simply runs out from between the layers.

McGee describes a process for preparing puff pastry dough. Pastry flour is mixed with ice water to make a moderately moist initial dough, with about 50 parts water per 100 parts flour. The mixing is done with minimal manipulation to minimize gluten development. The dough is shaped into a square. Next the fat, weighing about half the initial dough weight is pounded with a rolling pin until it becomes pliable, its consistency matching the consistency of the dough. Firmer fat would tear the dough, softer fat would be squeezed out during later rolling. The fat is formed into a flat piece, placed on the dough square, and the combination repeatedly folded onto itself and rolled out, with turns to vary the direction of rolling and rests in the refrigerator to give the fat a chance to re-solidify and the gluten to relax. The sequence of turning, rolling, folding and refrigerating is repeated several times for a total of six “turns”. The result of this work is a dough made up of 729 layers of moistened flour separated by 728 layers of fat. After baking, the pastry thus has an aerated and light sheeting.

UK 2070408 describes the preparation of a puff pastry in which the flour, water, salt and fat lumps are mixed together so as to obtain a heterogeneous dough having lumps of fat. This dough is laminated and placed in a cool place before being cut into a large number of laminations, preferably 0.25 mm to 3 mm thick, which are then agglomerated together so as to produce a heterogeneous dough having lumps of fat and consisting of a superposition of sheets. Next, the puff pastry thus produced is laminated into a dough 5 to 6 m mm thick and is used for the production of food products.

US2001/0022984 describes a process for the preparation of puff pastry by extrusion, the example of the fat used is a puff pastry margarine.

There is a need in the industry to find better solutions to produce laminated pastry, in particular laminated pastries having a reduced level of saturated fat. An object of the present invention is to improve the state of the art and to provide an improved solution to overcome at least some of the inconveniences described above or at least to provide a useful alternative. Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The object of the present invention is achieved by the subject matter of the independent claims. The dependent claims further develop the idea of the present invention.

### SUMMARY OF THE INVENTION

Accordingly, the present invention provides in a first aspect a method for forming a laminated pastry wherein a lipid foam is laminated between layers of dough. In a second aspect, the invention relates to a laminated pastry having a saturated fatty acid content less than 45 wt. % of the total fatty acids in the pastry.

It has surprisingly been found by the inventors that a lipid foam may be used to partly or completely replace the laminating fat in laminated pastries. The lipid foam provides a suitable consistency for the lamination process even when fats with lower levels of saturated fatty acids than conventional laminated pastry fats are used as the lipid material.

### BRIEF DESCRIPTION OF THE DRAWINGS

FIG. 1 shows a differential scanning calorimeter crystallization and melting trace for 20 wt. % cocoa butter in high oleic sunflower oil.

FIG. 2 shows a 20 wt. % cocoa butter in high oleic sunflower oil foam, prepared as described in example 1, trial 1.2, after 7 days of storage.

FIG. 3 shows a 20 wt. % cocoa butter in high oleic sunflower oil foam, prepared as described in example 1, trial 1.3, after 7 days of storage.

FIG. 4 shows a differential scanning calorimeter crystallization and melting trace for 20 wt. % monoglyceride in high oleic sunflower oil.

FIG. 5 shows the rheology of the gel forming of 10% Dimodan HR in HOSFO, when cooling from 90° C. to 20° C.

FIG. 6 shows foamed high stearic sunflower oil stearin stored at 20° C. for 1 day (top image) and 2 weeks (bottom image).

FIG. 7 (right-hand side) shows crystals absorbed at the surface of bubbles in a micrograph of a foam of 10% monoglyceride in high oleic sunflower oil, diluted by a factor of 4. The left-hand side is a diagrammatic representation of how the crystals create a non-relaxing shape.

FIG. 8 is a micrograph of the cocoa butter/high oleic sunflower oil foam formed in trial 1.5, diluted with oil.

FIG. 9 is a micrograph showing crystals coating the interfaces between bubbles in a monoglyceride/high oleic sunflower oil foam diluted with oil.

FIG. 10 shows an optical micrograph of a foamed 10% monoglyceride gel, diluted in HOSFO: showing the bubble “poles”

FIG. 11 as FIG. 10, but showing non-spherical bubbles

FIG. 12 is a zoom of the same image as FIG. 11

FIG. 13 is a higher magnification image of the same sample as FIG. 10 (scale bar 20 μm)

FIG. 14 shows an optical micrograph of a foamed 10% Dimodan HR gel, diluted in HOSFO: showing the bubble “equatorial” plan

FIG. 15 is a zoom of the same image as FIG. 14

FIG. 16 is a micrograph of a foam consisting of high oleic sunflower oil and cocoa butter improver

FIG. 17 is a further micrograph of the foam shown in FIG. 16

FIG. 18 shows layers in a puff pastry laminated with a lipid foam

FIG. 19 shows cooked puff pastries from Example 9, reference on the left, trial on the right.

FIG. 20 shows the preparation of filled sandwiches, the pastry laminated with a lipid foam.

### DETAILED DESCRIPTION OF THE INVENTION

Consequently the present invention relates in part to method for forming a laminated pastry wherein a lipid foam is laminated between layers of dough. In the context of the present invention the term “lipid foam” refers to a material comprising a continuous lipid phase and dispersed gas, for example air. The lipid foam according to the method of the invention may have a porosity of between 1 and 80%, for example between 10 and 75%, for example between 30 and 70%. The lipid foam may comprise glycerides selected from the group consisting of monoglycerides, diglycerides, triglycerides, esters of monoglycerides, esters of diglycerides and combinations of these. The lipid foam may comprise at least 50 wt. % triglycerides. Triglycerides, also called triacylglycerols or triacylglycerides, are esters derived from glycerol and three fatty acids. Diglycerides are esters derived from glycerol and two fatty acids and monoglycerides are esters derived from glycerol and one fatty acid. In the context of the present invention, the term “fat” refers to materials primarily composed of triglycerides. Fats are the chief component of animal adipose tissue and many plant seeds. Fats which are generally encountered in their liquid form are commonly referred to as oils. In the present invention the terms oils and fats are interchangeable.

The lipid foam may comprise water, for example water may be emulsified into the continuous lipid phase of the lipid foam. The lipid foam laminated between layers of dough in the method of the invention may contain between 10 and 30% water. Having water in a lamination fat helps the pastry to expand as the water turns to steam during baking. However, having water in the lipid foam is not essential for the method, the lipid foam may contain less than 5 wt. % water, for example less than 2 wt. % water. Food ingredients that are completely free from moisture are rare, but the lipid foam according to the method of the invention may be essentially free from water.

The laminated pastry according to the method of the invention may be a puff pastry (including quick puff pastry), croissant or Danish pastry.

In an embodiment of the method of the invention, the laminated pastry may be formed by a method comprising the steps a) forming dough into a sheet; b) applying a layer comprising (for example consisting of) the lipid foam to the dough sheet to form a combined sheet; and c) folding and compressing the combined sheet at least twice to form a laminated pastry. The combined sheet may for example be compressed by rolling, which additionally acts to stretch the dough.

In a further embodiment of the method of the invention, the laminated pastry may be formed by a method comprising the steps a) forming the lipid foam into small portions; b) mixing the lipid foam portions with flour to form a heterogeneous mixture with portions of lipid foam dispersed in the flour; c) adding water to the mixture to form a heterogeneous dough; and d) compressing the heterogeneous dough to flatten the dispersed lipid foam portions into thin sheets and form a laminated pastry. The combined sheet may for example be compressed by extruding or rolling. The lipid foam portions may be mixed into the flour with a blade type mixer. The flour may be any flour suitable for making pastry, for example the flour may be wheat flour. Small portions may be for example between 0.1 and 5 g.

Commercially, laminated pastry is provided to consumers in a number of forms. It may be sold as a chilled or frozen laminated pastry in an un-cooked state, for example for the consumer to use at home to prepare their own dishes. The laminated pastry according to the method of the invention may be stored at a temperature of −40° C. to +10° C. The laminated pastry may be baked, for example the laminated pastry may be baked before or after being stored at a temperature of −40° C. to +10° C.

Puff pastry is generally used as a contrasting container for a moist filling, whether savoury or sweet. The container may be open, as in tarts and open-faced pies, closed as in double-crust pies, or fully enclosed as in turnovers and filled sandwiches such as the Nestle product HOT POCKETS®. A filling may be enclosed by the laminated pastry according to the method of the invention, the filling being selected from the group consisting of a sweet filing, a savoury filling, and combinations thereof.

The lipid foam according to the method of the invention may have a continuous lipid phase and a porosity of between 1 and 80%. The lipid foam may have a high content of fats liquid at room temperature, for example the lipid foam may have greater than 50% of the total lipid being fats liquid at 20° C. The lipid foam may have a solid lipid content below 30% at 10° C., for example below 25% at 10° C., for further example below 20% at 10° C.

In an embodiment of the invention, the lipid-air interface of the gas bubbles in the lipid foam may be stabilized by glyceride crystals, for example the interface may be stabilized by glyceride crystals that occupy the surface of the gas bubbles such that the crystals jam together. Surprisingly, by cooling a liquid lipid composition to a temperature at which there is partial crystallization and a gel is formed and then whipping the composition, a stable foam is produced. This stable foam may advantageously be used as a partial or complete replacement of the lamination fat of a laminated pastry. The gas bubbles in the foam were found to be coated in lipid crystals. By using a process of prolonged and intensive whipping, very stable assemblies of crystal-wrapped bubbles can be obtained. The crystals jam together around the bubble, leading to mechanical stability and resisting bubble shrinkage. The bulk remains soft, e.g. there is no rigid network of crystals in between the bubbles. The foam can be diluted with oil (liquid lipid) and still remain stable (unless so much oil is added that it dissolves the crystals). The foam may be further cooled such that the continuous phase solidifies, but if the foam is re-heated and the continuous phase re-melts, the stable crystal-wrapped bubbles remain until the temperature is raised to the point where all crystals melt (or substantially all the crystals melt).

Stabilizing the gas bubbles in the lipid foam by glyceride crystals occupying the surface of the gas bubbles allows a lipid foam with particularly low levels of solid lipid to remain stable during the process of laminating a pastry, and so allows the manufacture of laminated pastries with reduced levels of saturated fats to be produced. Accordingly, in the “crystal-wrapped bubbles” embodiment, the lipid foam according to the method of the invention may have a continuous lipid phase and a porosity of between 1 and 80%, wherein, at a temperature at which the lipid phase has a solid lipid content between 0.1 and 80% (for example 0.1 and 80%, for example between 0.5 and 60%, for example between 0.5 and 40%, for example between 1 and 20%, for example between 5 and 20%) the lipid foam may comprise gas bubbles having at least 50% of their surface occupied by crystals, the crystals comprising a glyceride selected from the group consisting of monoglycerides, diglycerides, triglycerides, esters of monoglycerides, esters of diglycerides and combinations of these. The crystals occupying the surface of the gas bubbles may comprise triglycerides, for example they may consist of triglycerides.

The percentage of the gas bubbles' surface occupied by crystals may be measured using microscopy (for example optical and/or confocal microscopy), coupled with suitable image analysis techniques. With a high level of surface coverage it may be immediately obvious after inspection by microscopy that at least 50% of the surface of the gas bubbles is occupied by crystals.

The crystals occupying at least 50% of the surface of the gas bubbles jam together, resisting any shrinkage of the bubbles and providing a stable, flowable foam when the continuous phase is fluid, such as when the lipid phase has a solid lipid content between 0.1 and 80%. The crystals occupying at least 50% of the surface of the gas bubbles may cause the bubbles to have a non-relaxing shape when the foams are diluted with oil. In the context of the present invention the term flowable foam refers to a foam which can be processed in pumping or stirring units using typical food process equipment without undergoing obvious structural coarsening or collapse. The flowable foam may be flowable under gravity after stirring (for example at 20° C.).

The term porosity refers to the fraction of the volume of gas-filled voids over the total volume, as a percentage between 0 and 100%. The lipid phase of the foam may comprise lipidic solids, semisolids or liquids. The solid lipid content at different temperatures may be measured by pulsed NMR, for example according to the IUPAC Method 2.150. The solid lipid content at different temperatures may also be measured by differential scanning calorimetry. The result of a measurement of solid lipid content is commonly referred to as the solid fat content. Although it is possible to obtain solid lipid contents intermediate between 0 and 100% with pure lipid compositions by exploiting the kinetics of crystallization and heat transfer, in general it is preferable that the lipid phase comprises a mixture of different lipids with different melting points. Indeed, pure lipids are expensive and so are not preferred.

The lipid foam according to the “crystal-wrapped bubbles” embodiment of the method of the invention may comprise gas bubbles having their surface occupied by glyceride crystals, such that the surface density is at least 15 mg·m⁻², for example at least 25 mg·m⁻² for example at least 50 mg·m⁻², for further example at least 200 mg·m⁻²
Interfacial area (S) developed by a foam:

$$S = \frac{6 φ V}{D}$$

V: volume of foam (m³)
ϕ: porosity
D: bubble Sauter diameter (m) as measured by optical microscopy/tomography
Concentration of adsorbed glycerides at interface:

c_{ads}=cᵢₙᵢ−c_{non-ads}×X

C_{ads}: glyceride concentration, relative to the oil phase, adsorbed at the air-oil interface of the bubbles
Cᵢₙᵢ: initial concentration of glyceride in the gel
C_{non-ads}: non-adsorbed glyceride concentration as titrated from the diluted subnatant
X: dilution factor applied to the foam before collecting the subnatant
Adsorption surface density:

$$Γ = \frac{{c}_{ads} ( 1 - φ ) V}{S}$$

The lipid foam according to the “crystal-wrapped bubbles” embodiment of the method of the invention may have a continuous lipid phase and a porosity of between 1 and 80% (for example between 10 and 75%, for example between 30 and 70%) wherein, at a temperature at which the lipid phase has a solid lipid content between 0.1 and 80%, the foam comprises gas bubbles having at least 50% of their surface occupied by crystals, the crystals comprising glycerides having fatty acid groups of between 12 and 22 carbons. The crystals occupying the surface of the gas bubbles may comprise monoglycerides having fatty acid groups of between 12 and 22 carbons. It is beneficial to be able to stabilize a lipid foam without needing to use glycerides with high chain length fatty acids. Such high chain length fatty acids, especially saturated ones, affect the organoleptic properties of the pastry, giving a waxy mouthfeel. The gas bubbles comprised within the lipid foam according to the “crystal-wrapped bubbles” embodiment of the method of the invention may have their surface occupied by glycerides all of whose fatty acids have a carbon chain length less than 22. The gas bubbles comprised within the lipid foam according to the “crystal-wrapped bubbles” embodiment of the method of the invention may have their surface occupied by glycerides all of which have an average fatty acid chain length less than 20. For example, the triglyceride palmitic-oleic-stearic (POSt) has an average chain length of 17.3 as palmitic acid is C16, oleic acid is C18 and stearic acid is C18.

The lipid foam according to the method of the invention may contain more than 95% (for example more than 98%, for further example more than 99%) of glycerides on a total lipid weight basis, all of whose fatty acids have a carbon chain length less than 22. The lipid foam according to the method of the invention may contain more than 95% by weight of total lipids (for example more than 98%, for further example more than 99%) of glycerides all of whose fatty acids have an average chain length less than 20.

The crystallization behaviour of the lipid phase of the lipid foam according to the method of the invention may be examined using differential scanning calorimetry (DSC), a technique in which the difference in the amount of heat required to increase the temperature of a sample and reference is measured as a function of temperature. For example, a sample comprising the lipid phase may be heated to completely melt all the lipid, cooled to record the crystallization signature and then reheated to record the melting signature. When the cooling protocol brings the mixture so low in temperature that the system solidifies in bulk then the lipid phase in the foam of the “crystal-wrapped bubbles” embodiment of the method of the invention may show at least two distinct endothermic melting “peaks” during the reheating phase, the at least two endothermic melting “peaks” being separated by at least 10° C., for example at least 15° C., for example at least 20° C. The area under each of the at least two peaks may be at least 10% of the area under all peaks in the melting trace. Depending on the DSC equipment used, endothermic heat flows may be shown as positive or negative peaks.

The crystals comprising a glyceride occupying the surface of the gas bubbles in the lipid foam according to the “crystal-wrapped bubbles” embodiment of the method of the invention may form layers having an average thickness below 5 μm, for example between 0.2 and 5 μm. The lipid crystals comprising glycerides occupying the surface of the gas bubbles in the lipid foam according to the “crystal-wrapped bubbles” embodiment of the method of the invention may form layers having an average thickness below 2 μm, for example between 0.2 and 2 μm. The lipid crystals comprising glycerides occupying the surface of the gas bubbles in the lipid foam according to the “crystal-wrapped bubbles” embodiment of the method of the invention may form layers having an average thickness between 0.01 μm and 5 μm, for example between 0.05 μm and 2 μm, for further example between 0.2 μm and 1 μm. Thin layers of crystals provide an advantage as a smaller amount of crystals are required to wrap the bubbles and hence a smaller amount of higher melting components.

The lipid foam according to the “crystal-wrapped bubbles” embodiment of the method of the invention may have no rigid network in the continuous lipid phase at a temperature at which the lipid phase has a solid lipid content between 0.1 and 80%. For example the lipid foam according to the “crystal-wrapped bubbles” embodiment of the method of the invention, at a temperature at which the lipid phase has a solid lipid content between 0.1 and 80% (for example between 0.1 and 60%, for example between 0.5 and 40%, for example between 1 and 20%, for example between 5 and 20%), may flow under gravity without losing more than 10% of its porosity (for example without losing more than 5% of its porosity). A rigid network is present when flow induces partial instability of the structure. On applying shear to a rigid network, a solid type of initial flow is observed. For example if a system having a rigid network is sheared in a rheometer, an initial resistance of elastic (or rigid) type would be observed, followed by a transition through maximal resistance (breakage of the rigid structure) before the structure would return to being flowable (at least in part). The transition is then not rapidly reversible (no rapid recovery of the rigid network e.g. within a few seconds or minutes). This is in contrast to the behaviour of foams having no rigid network.

Most lipid materials used commercially are mixtures of different molecules. Vegetable and animal fats for example contain a range of different glycerides. As a consequence, when cooling these fats, a fraction of the fat will start to crystalize while the rest of the fat remains liquid. Surprisingly, by cooling liquid fats so that part of the lipids crystallize and a gel forms, and then aerating the gel, a stable foam may be produced. The gel structure may continue to develop during and after foaming. For example, on cooling olive oil to −23° C. a gel forms. Whipping the gel creates a stable foam with gas bubbles having their surface occupied by glyceride crystals. For ease of processing, the temperature may be raised before whipping, as long as some crystals and the gel remain. In such a foam, no additional stabilizer material needs to be added to the liquid fat to enable a foam to be formed. The semi-crystalline nature of the lipid and the presence of bubbles stabilized by crystals results in a lipid foam which remains stable during pastry lamination at a liquid fat content that would otherwise be un-processable. Normally, highly liquid fats would simply flow out from between the pastry layers. Accordingly, in the “crystal-wrapped bubbles” embodiment of the method of the invention, the lipid phase may comprise one or more fats and the crystals comprising glycerides occupying the surface of the gas bubbles may comprise glycerides from all the one or more fats. The fats may be vegetable fats. The fats may be selected from the group consisting of cocoa butter, olive oil, high stearic sunflower oil and combinations of these. The composition of glycerides occupying surface of the gas bubbles may be richer in higher melting glycerides than the bulk fat.

In the “crystal-wrapped bubbles” embodiment of the method of the invention, one or more higher melting-point lipid ingredients may be included in the lipid phase of the aerated fat-based confectionery material to promote the formation of crystals to occupy the surface of the gas bubbles when the majority of the lipid phase is still liquid. For example the lipid phase of the lipid foam according to the “crystal-wrapped bubbles” embodiment of the method of the invention may provide an aerated fat-based confectionery material wherein the lipid phase comprises one or more higher melting-point (HMP) lipid ingredients and one or more lower melting-point (LMP) lipid ingredients and wherein the melting-point of the lowest melting higher melting-point lipid ingredient is at least 10° C., for example at least 15° C., for example at least 20° C., above that of the melting point of the highest melting lower melting-point lipid ingredient and wherein the lower melting-point lipid ingredients are present at a level of greater than 50 wt. % of the total lipid in the lipid phase, for example greater than 60 wt. %, for example greater than 70 wt. %, for example greater than 90 wt. %. A lipid phase composition as described facilitates the formation and stability of the lipid foam, with crystals from the higher melting-point lipid ingredients occupying the gas bubble surfaces while the lower melting-point lipid ingredients maintain a fluid continuous phase to enable aeration, for example by whipping.

Consider a lipid phase which consists of 6 wt. % Dimodan HR (mpt. 72° C.), 40 wt. % cocoa butter (mpt. 35° C.) and 54 wt. % high oleic sunflower oil (mpt. −17° C.). The lipid phase has two HMP lipid ingredients (Dimodan HR and cocoa butter) and one LMP lipid ingredient (high oleic sunflower oil). The melting point of the lowest melting HMP lipid ingredient (cocoa butter) is 35° C., which is at least 10° C. above that of the melting point of the highest melting LMP lipid ingredient, i.e. high oleic sunflower oil with a melting point of −17° C. The LMP lipid ingredient (HOSFO) is present at 54 wt. % of the total lipid.

The melting points of the lipid ingredients in the lipid phase of the lipid foam according to the method of the invention may vary. The melting-point of the lowest melting HMP lipid ingredient may be above 10° C., for example above 20° C., for example above 30° C., for example above 40° C. A combination of a small quantity of high melting lipid ingredient with a large amount of low melting lipid ingredient can provide a stable foam at room temperature and below which is particularly beneficial for forming laminated pastry as they achieve process stability without causing excessive waxiness in the mouth, and without an unwanted increase in saturated fat content. For example, the melting-point of the lowest melting HMP lipid ingredient may be above 40° C., for example between 40 and 90° C., and the lower melting-point lipid ingredients may be present at a level of greater than 90 wt. %. For example, the melting-point of the lowest melting HMP lipid ingredient may be above 30° C., for example between 30 and 50° C., and the lower melting-point lipid ingredients may be present at a level of greater than 75 wt. %. The crystals occupying the surface of the gas bubbles may comprise glycerides from the HMP lipid ingredients. Lipid ingredients present in minor quantities with melting-points between the temperature of the lowest melting HMP lipid ingredient and the highest melting LMP lipid ingredients do not significantly affect the efficiency of foam formation. The melting-point of the lowest melting higher melting-point lipid ingredient may be at least 10° C., for example at least 15° C., for example at least 20° C., above that of the melting point of the highest melting lower melting-point lipid ingredient when lipid ingredients present at levels below 1 wt. % of the lipid content of the lipid phase are discounted. The melting-point of a fat may for example be the temperature at which it has a 1% solid fat content as measured by pulsed NMR.

The one or more higher melting-point lipid ingredients in the lipid foam according to the method of the invention may be selected from the group consisting of monoglycerides, diglycerides, esters of monoglycerides, esters of diglycerides, cocoa butter, shea butter, illipe butter, sal nut oil, mango kernel fat, palm kernel oil, palm oil, coconut oil, milk fat, high stearic sunflower oil and hydrogenation products, inter-esterification products, fractions and combinations of these; and the one or more lower melting-point lipid ingredients may be selected from the group comprising sunflower oil (high oleic and standard), coconut oil, safflower oil, rapeseed oil, olive oil and combinations and fractions of these. The one or more higher melting-point lipid ingredients in the lipid foam according to the method of the invention may be selected from the group consisting of monoglycerides, diglycerides, cocoa butter, shea butter, illipe butter, sal nut oil, mango kernel fat, palm kernel oil, palm oil, coconut oil, milk fat, high stearic algal oil, high stearic sunflower oil and hydrogenation products, inter-esterification products, fractions and combinations of these; and the one or more lower melting-point lipid ingredients may be selected from the group comprising sunflower oil (high oleic and standard), coconut oil, safflower oil, rapeseed oil, olive oil and combinations and fractions of these. The one or more higher melting-point lipid ingredients in the lipid foam according to the method of the invention may be selected from the group consisting of cocoa butter, shea butter, illipe butter, sal nut oil, mango kernel fat, palm kernel oil, palm oil, coconut oil, milk fat, high stearic sunflower oil and hydrogenation products, inter-esterification products, fractions and combinations of these; and the one or more lower melting-point lipid ingredients may be selected from the group comprising sunflower oil (high oleic and standard), coconut oil, safflower oil, rapeseed oil, olive oil and combinations and fractions of these. The one or more higher melting-point lipid ingredients in the lipid foam according to the method of the invention may have a melting point above 20° C. and the one or more lower melting-point lipid ingredients in the lipid foam according to the method of the invention may have a melting point below 20° C.

The higher melting-point lipid ingredients in the lipid foam according to the method of the invention may comprise monoglycerides, for example monoglycerides having fatty acid groups of between 12 and 22 carbons, and the lower melting-point lipid ingredients in the aerated fat-based confectionery material of the invention may comprise sunflower oil, for example high oleic sunflower oil. The higher melting-point lipid ingredients in the lipid foam according to the method of the invention may comprise monoglycerides, for example monoglycerides having fatty acid groups of between 12 and 22 carbons, and the lower melting-point lipid ingredients in the lipid foam according to the method of the invention may comprise coconut oil. The higher melting-point lipid ingredients in the lipid foam according to the method of the invention may comprise a mixture of monoglycerides and diglycerides, and the lower melting-point lipid ingredients in the lipid foam according to the method of the invention may comprise sunflower oil, for example high oleic sunflower oil. The higher melting-point lipid ingredients in the lipid foam according to the method of the invention may comprise esters of monoglycerides and esters of diglycerides, for example lactic acid esters of monoglycerides and diglycerides or acetic acid esters of monoglycerides and diglycerides, and the lower melting-point lipid ingredients in the lipid foam according to the method of the invention may comprise sunflower oil, for example high oleic sunflower oil.

The inventors have found that the addition of particles may aid the foam stability of the lipid foam according to the method of the invention, reducing coarsening over time and providing better foam homogeneity. Solid particles having a particle size of less than 500 μm may be dispersed in the lipid foam. Particle size may be measured by the methods known in the art consistent with the size being measured. For example, a particle size less than 500 μm may be confirmed by passage through a standard US sieve mesh 35. The solid particles dispersed in the foam may have a particle size less than 180 μm (e.g. measured by passage through US mesh 80). The solid particles dispersed in the foam may have a D90 particle size measured by laser light scattering of less than 100 μm, for example less than 50 μm, for example less than 30 μm. The solid particles dispersed in the lipid foam may be selected from the group consisting of modified starch, maltodextrin, inorganic salt (for example edible inorganic salt), protein particles, plant particles (for example cocoa particles, coffee particles, spices or herbs), sugars (for example sucrose), and combinations of these. The solid particles dispersed in the lipid foam may be maltodextrin. The solid particles may be present at a level of between 1 and 500% of the total lipid weight in the foam, for example between 1 and 200% of the total lipid weight in the foam, for example between 1 and 100% of the total lipid weight in the foam, for example between 1 and 20% of the total lipid weight in the foam, for further example between 5 and 20% of the total lipid weight in the foam.

Typically, lower melting lipid ingredients have lower levels of saturated fatty acids than higher melting lipid ingredients. Consumption of saturated fatty acids have been linked to increased levels of LDL cholesterol in the blood and heart diseases. It is advantageous to be able to provide laminated pastries with lower levels of saturated fatty acids. By being able to create a foam from a lipid phase with a high percentage of lower melting lipid ingredients, for example by the “crystal-wrapped bubbles” embodiment of the method of the invention, the saturated fatty acid content of laminated pastries may be reduced. The lipid foam according to the method of the invention may be low in saturated fatty acids, for example the lipid foam may have a saturated fatty acid content of less than 45 wt. % of the total fatty acid content, for example less than 35 wt. % of the total fatty acid content. In an embodiment of the method of the invention, the lipid foam may comprise between 5 and 20% by weight of total lipid of a fat having a saturated fatty acid content of between 50 and 70% (for example between 10 and 15%) and between 80 and 95% by weight of total lipid (for example between 85 and 90% by weight of total lipid) of a fat having a saturated fatty acid content of between 0 and 20%. As the lipid foam is aerated, it provides an equivalent volume for less weight of material and hence reduces the total fat required to prepare a laminated pastry.

The lipid foam according to one aspect of the method of the invention may be formed by a method comprising the steps of providing a composition having a lipid content greater than 20 wt. %, for example greater than 30 wt. %, for example greater than 50 wt. %, for example greater than 60 wt. %; controlling the temperature of the composition such that the composition comprises glyceride crystals, has a solid lipid content (for example a solid lipid content after the temperature control) between 0.1 and 80% (for example between 0.5 and 60%, for example between 0.5 and 40%, for example between 1 and 20%, for example between 5 and 20%); and aerating the composition comprising glyceride crystals, for example to form a foam. The lipid foam may be formed by a method comprising the steps of providing a composition having a lipid content greater than 20 wt. %, for example greater than 30 wt. %, for example greater than 50 wt. %, for example greater than 60 wt. %; controlling the temperature of the composition such that the composition comprises glyceride crystals, has a solid lipid content (for example a solid lipid content after the temperature control) between 0.1 and 80% (for example between 0.5 and 60%, for example between 0.5 and 40%, for example between 1 and 20%, for example between 5 and 20%) and forms a gel; and aerating the gel, for example to form a foam. The lipid foam may comprise gas bubbles having their surface occupied by crystals comprising glycerides. In the context of the present invention the term aerating refers to foaming by the incorporation of gas bubbles, the gas not necessarily being air. Aeration may be achieved by any of the techniques known in industry, for example mechanical agitation, passive mixing (e.g. passing through slit or nozzle), pressure drop (e.g. to vacuum, or from elevated pressure to atmospheric pressure) or sparging (when a chemically inert gas is bubbled through a liquid). A gel is a non-fluid network characterised by a continuous liquid throughout its whole volume. The gel of the process of the invention may have a continuous lipid phase. The gel of the process of the invention may have a gel property arising from a crystal network, for example a network of crystals of average size below 100 microns throughout the matrix. The gel of the process of the invention may have between 3 and 30% of the total lipid by weight in the form of crystals, for example between 5 and 20%. A gel may be defined by its rheology. For example at a frequency of 1 Hz, the measured linear shear elastic modulus G′ of a gel may be greater than 10 Pa and the viscous modulus G″ may be less than G′. Gels most suitable for foam generation have a linear shear elastic modulus G′ initially in the range 10²-10⁷ Pa at 1 Hz, for example a linear shear elastic modulus G′ initially in the range 10²-10⁶ Pa at 1 Hz, for further example a linear shear elastic modulus G′ initially in the range 10³-10⁶ Pa at 1 Hz.

The composition in the formation of the lipid foam in one aspect of the method of the invention may comprise a range of different lipid ingredients with different melting points. The crystallization behaviour of the composition may be examined using differential scanning calorimetry (DSC). Aeration may be performed at a temperature below the highest melting peak maximum, the temperature being such that the solid lipid content is between 0.1 and 80%, preferably at a temperature below the whole peak area of the highest endothermic melting peak.

The lipid phase of the lipid foam in the method of the invention may have at least 80% of its total crystallization enthalpy between 80° C. and −20° C. occurring in a temperature range of at least 20° C., for example a range of at least 30° C. The lipid phase of the lipid foam may have at least 50% of its total crystallization enthalpy between 80° C. and −20° C. occurring in a temperature range between 40° C. and 15° C., for example at least 80% of its total crystallization enthalpy between 80° C. and −20° C. occurring in a temperature range between 40° C. and 15° C. The lipid phase of the lipid foam in the method of the invention may have at least 50% of its total crystallization enthalpy between 80° C. and −20° C. occurring in a temperature range between 20° C. and −5° C., for example at least 80% of its total crystallization enthalpy between 80° C. and −20° C. occurring in a temperature range between 20° C. and −5° C.

Cooling the composition to form the lipid foam in one aspect of the method of the invention will promote the formation of crystals. This can be enhanced by the addition of small glyceride crystals, for example glyceride crystals of a higher melting-point lipid ingredient. The added glyceride crystals may themselves occupy the surface of the gas bubbles when the gel is aerated, or they may promote the growth of glyceride crystals which occupy the surface of the gas bubbles or a mixture of both. Accordingly, glyceride crystals may be added to the composition used to form the lipid foam, for example they may be added whilst controlling the temperature of the lipid composition such that the composition has a solid lipid content between 0.1 and 80% and the composition forms a gel. The glyceride crystals may be selected from the group consisting of monoglycerides, diglycerides, triglycerides, esters of monoglycerides, esters of diglycerides and combinations of these.

The composition used to form the lipid foam may initially be at a temperature at which it contains less than 0.1% solid lipid in the process of the invention. For example it may be at a temperature at which it contains no solid lipid. Starting with less than 0.1% solid lipid, or no solid lipid, makes it easier to control the conditions such that a proportion of the composition crystallizes, providing suitable glyceride crystals for occupying the surface of gas bubbles in the foam.

Improved results (e.g. lower density foams and greater stability) may be obtained if the gel is allowed to mature before being aerated. There may be a time interval of at least 5 minutes between the formation of the gel and the start of the aeration in the process of the invention. The time interval between the formation of the gel and the start of the aeration in the process of the invention may be at least 30 minutes, for example at least 1 hour, for example at least 24 hours, for example at least 4 weeks. The gel may be maintained at any temperature during the time between formation of the gel and the start of the aeration as long as the composition maintains a solid lipid content between 0.1 and 80%. The higher the temperature of the gel when it is whipped, the lower the density of foam obtained, providing the temperature is not raised to the point that all lipid crystals melt and the gel is destroyed. For example, the composition used to form the lipid foam may be cooled rapidly, such as in a freezer at −18° C. to form a gel, and then allowed to warm up to a temperature at which only a few percent solid lipid remains before being aerated.

The aeration step used to form the lipid foam according to the method of the invention may comprise mechanical agitation, for example whipping. Although foams could be obtained by non-mechanical agitation methods, such as dissolving or dispersing gas under pressure and then releasing it; to obtain the most stable foams it was preferable to apply mechanical agitation. Without wishing to be constrained by theory, it is believed that mechanical agitation increases the wrapping of the gas bubbles with lipid crystals. Mechanical agitation may for example be applied using rotor-stator type of equipment, such as a Haas-Mondomix aerating system. After formation, and maturation (if any), the gel may be gently sheared to allow an easy transfer to the aerating system. Mechanical agitation, for example whipping, may be applied for at least 5 s (such as the residence times in a continuous rotor-stator system), for example at least 1 minute, for example at least 5 minutes (such as in a batch whipping machine), for example at least 10 minutes. For example, mechanical agitation, for example whipping, may be applied for between 10 seconds and 1 hour, for example between 1 minute and 30 minutes, for further example between 5 minute and 20 minutes. Foam stability generally increases with increasing mechanical agitation time. In contrast to many foams, crystal wrapped bubbles are not particularly sensitive to over-whipping. The aeration step may comprise gas depressurization followed by mechanical whipping. Such a combination of initial bubble generation using dissolved/dispersed gas and a pressure drop followed by mechanical agitation may usefully be employed, however all process steps may be performed at or near atmospheric pressure, for example between 800 hPa and 2100 hPa, for example between 850 hPa and 1100 hPa.

The method of the invention may further comprise adding additional materials. For example, materials such as flour may be added to the lipid foam during its preparation. Flour may for example be mixed with a lipid which is then aerated, or flour may be mixed into a lipid which is in turn mixed into further aerated lipid. The lipid foam according to the method of the invention may be generated by a method comprising the steps of providing a composition consisting of lipids and comprising glycerides selected from the group consisting of monoglycerides, diglycerides, triglycerides, esters of monoglycerides, esters of diglycerides and combinations of these; controlling the temperature of the composition such that the composition comprises glyceride crystals, has a solid lipid content between 0.1 and 80% and forms a gel; adding a non-aerated lipid-containing material to the gel; then aerating the gel.

The lipid foam according to the method of the invention may be prepared by first foaming a composition having a high lipid content and then combining it with a non-aerated composition, for example a non-aerated lipid. Lipid-continuous compositions with low lipid contents are difficult to aerate, as the foam structure tends to break during whipping. By creating an initial lipid foam using a composition with a high lipid content and then carefully mixing the initial foam with an un-aerated material having a lower fat content to form the lipid foam according to the method of the invention, a much higher porosity can be obtained than by whipping the final composition directly.

The lipid foam may be allowed to mature before additional ingredients are added. For example the time interval between the formation of the foam and the addition of further ingredients, may be at least 30 minutes, for example at least 1 hour, for example at least 24 hours, for example at least 4 weeks.

In an embodiment of the method of the invention, the lipid foam may be formed by a method comprising the steps of providing a composition having a higher melting-point fat content between 5 and 20% by weight (for example between 10 and 15% by weight) and a lower melting-point fat content between 80 and 95% by weight (for example between 85 and 90% by weight), wherein the higher melting-point fat has a melting point between 30 and 50° C. (for example between 35 and 45° C.) and the lower melting-point fat has a melting point between below 0° C. (for example below −10° C.); cooling the composition to a temperature between 0 and 25° C. (for example between 0 and 20° C.) such that the composition comprises triglyceride crystals, has a solid lipid content (for example after cooling) between 0.1 and 80% (for example between 5 and 20%) and forms a gel; and aerating the gel (for example by mechanical whipping) to form a foam. The composition may be free from lipid crystals before being cooled. The higher melting-point fat may have a saturated fatty acid content of between 50 and 70% and the lower melting-point fat may have a saturated fatty acid content of between 0 and 20%. The resulting foam may optionally be mixed with an un-aerated lipid-continuous composition to form the lipid foam according to the method of the invention.

In a further aspect, the invention provides a laminated pastry having a saturated fatty acid content less than 45 wt. % (for example less than 35 wt. %, for example less than 18 wt. %) of the total fatty acids in the pastry. In an embodiment, the laminated pastry of the invention may be a chilled or frozen ready-to-cook pastry having a lipid foam laminated between layers of dough. The invention provides for the use of lipid foam to reduce the saturated fatty acid content of a laminated pastry.

Those skilled in the art will understand that they can freely combine all features of the present invention disclosed herein. In particular, features described for the method of the present invention may be combined with the product of the present invention and vice versa. Further, features described for different embodiments of the present invention may be combined. Where known equivalents exist to specific features, such equivalents are incorporated as if specifically referred to in this specification. Further advantages and features of the present invention are apparent from the figures and non-limiting examples.

### EXAMPLES

### Example 1: Formation of Stable Foams with Cocoa Butter in High Oleic Sunflower Oil

High Oleic Sunflower Oil (HOSFO) having a melting point of −17° C. (±3°) C. was obtained from (SABO Nestrade). Cocoa butter (Pure Prime Pressed) having a melting point of 35° C. (±3°) C. was obtained from Cargill.

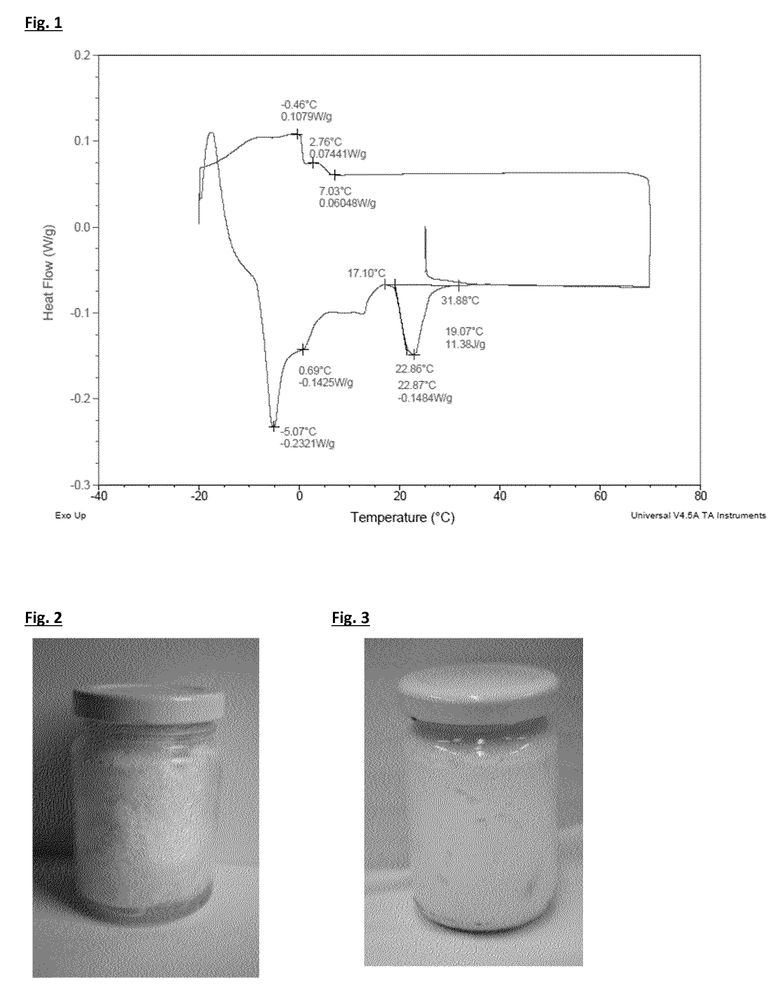

The melting and crystallizing profile of 20 wt. % cocoa butter in HOSFO was measured by DSC using a SDT 0600 from TA instruments. A sample of around 10-20 mg of cocoa butter in HOSFO was heated to 70° C. before recording the crystallization signature. After cooling to −20° C., it was reheated to 70° C. to record the melting signature. The DSC trace is shown in FIG. 1. It can be seen that the highest melting peak has a peak maximum at about 23° C. and the peak starts at around 17° C. Although different lipids and crystalline forms may have slightly different specific melting enthalpies, the area under the melting peaks in the reheating trace provides a reasonable correlation with the quantity of lipid melting. From the DSC reheating trace it can be seen that by 5° C. less than 60% of the lipid remains solid.

### 1.1 Gel at 4° C., Whipping at 20° C.

Mix preparation: 20% (w/w) cocoa butter in HOSFO was heated to 70° C. until complete dissolution. 250 g of the heated solution was placed in a double-jacketed glass container. The mixture was cooled down over 20 hours by applying water at 4° C. to the jacket. The gel obtained was placed at 20° C. in a Hobart N50 planetary kitchen mixer fitted with a balloon whisk at speed 2 for 15, 30, 45 min. A foam with an overrun of 240% was obtained. (Overrun is the volume of gas incorporated into the foamed material/volume of the un-foamed material, expressed in %.) The bubble size distribution was wide, with an average size estimated in the range 0.02-0.05 mm, but with only a very small fraction (less than 5%) of bubbles larger than 0.1 mm. The foam had good stability at low temperatures, but if maintained at room temperature it collapsed over 1 hour.

### 1.2 Gel at 4° C., Whipping at 5° C.

The protocol was same as 1.1 above except that the whipping was performed at 5° C. by placing the kitchen mixer in a cold room. A high overrun foam was achieved (200% after 15 minutes whipping). Bubble size distribution was wide, with an average size estimated in the range 0.03-0.05 mm, but with only a very small fraction (less than 5%) of bubbles larger than 0.1 mm. The foam had good stability at low temperatures, but if maintained at room temperature after foaming, the foam showed around 1 cm of drainage after 7 days of storage at room temperature (see FIG. 2). The texture of the foam was much firmer and less prone to flow than that of the gel before whipping.

### 1.3 Gel Held at 5° C. for 1 Week—Foaming at 5° C.

The protocol was the same as 1.1 above, except that 250 g of the mix was stored at 5° C. for 1 week, which allowed for recrystallization. The gel was then whipped at 5° C. for 15 min, 30 min and 45 min. A high overrun foam was achieved (180% after 15 minutes whipping and 235% after 30 minutes whipping). Average bubble size was smaller than in the earlier trials, estimated to be 0.03-0.05 mm, leading to very white appearance of foam. Foam showed a better stability at room temperature, i.e. it could be stored for weeks without apparent macroscopic collapse, and with very limited drainage (below 1 mm of drainage after 7 days of storage) (see FIG. 3).

### 1.4 Gel Held at 5° C. for 1 Week—Foaming at 20° C.

The protocol was the same as in 1.3 above except that whipping was performed at 20° C. A high overrun foam was achieved (225% after 15 minutes). Stability and bubble size was similar to 1.3.

### 1.5. Gel Held at 5° C. for 2 Weeks—Foaming at 5° C.

The protocol was same as in 1.3 except the gel storage duration which was 2 weeks. The stability and bubble size was similar to 1.3.

Summary of results foaming 20% cocoa butter in high oleic sunflower oil:

| Conditions | Max overrun |
|---|---|
| Gel 4° C. - Foamed at 20° C. | 243% |
| Gel 4° C. - Foamed at 5° C. | 245% |
| Gel held at 5° C. for 1 week. Foamed at 5° C. | 235% |
| Gel held at 5° C. for 2 weeks. Foamed at 5° C. | 200% |
| Gel held at 5° C. for 1 week. Foamed at room temperature | 226% |

### Example 2: Foams with Cocoa Butter in High Oleic Sunflower Oil with Addition of Maltodextrin Particles

Mix preparation: 20 wt. % cocoa butter, 10 wt. % maltodextrin particles (DE11-14) in HOSFO was heated to 70° C. until complete dissolution of the cocoa butter. 250 g of the mix placed in a closed vial. The vial was placed in water, cooled within a double-jacketed container (cooling water at 4° C.) for 20 hours. The gel obtained was stored at 5° C. for 1 week before being placed in a Hobart kitchen mixer at 5° C. fitted with a balloon whisk and whipped at speed 2 for 15 min, 30 min and 45 min. The resulting foam was compared with trial 1.3 above which had the same conditions apart from no maltodextrin particles. The foam with maltodextrin particles has a maximum overrun of 214% (compared to 235% for the sample with no particles). However, the trial with maltodextrin had improved stability against coarsening over time and showed better homogeneity of the foam.

### Example 3: Foaming of Single Oil

High stearic sunflower oil stearin (Nutrisun) is a high melting fraction of sunflower oil. Melting point 32° C. (±3° C.).

The high stearic sunflower oil stearin was heated to 90° C. to ensure complete dissolution of crystals. 250 g of the heated solution was placed in a double-jacketed glass container. The mixture was cooled down over 20 hours by applying water at 20° C. to the jacket. The gel obtained was placed in a Hobart kitchen mixer fitted with a balloon whisk at speed 2 for 15 min. High overrun foam was made (max overrun=277% after 45 min whipping). This foam showed good heat stability without apparent macroscopic destabilization and without apparent drainage after 7 days of storage. Bubble size distribution was very wide, with an average size estimated in the range 0.06-0.08 mm, but with only a very small fraction (less than 5%) of bubbles larger than 0.1 mm. This demonstrates that foams may be produced from single fats, the crystals occupying the surface of the gas bubbles necessarily coming from the same fat.

### Example 4: Formation of Stable Foams with Monoglyceride in High Oleic Sunflower Oil

High Oleic Sunflower Oil (HOSFO) having a melting point of −17° C. (±3°) C. was obtained from SABO Nestrade. Monoglyceride (Dimodan HR) was obtained from Danisco.

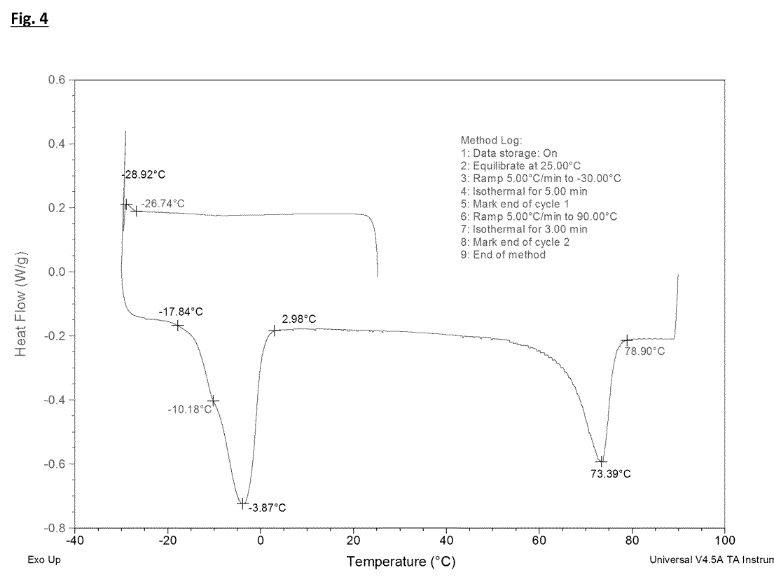

The melting and crystallizing profile of 20 wt. % monoglyceride in HOSFO was measured by DSC using a SDT Q600 from TA instruments. The sample was recrystallized at room temperature over an extended period before being cooled to −30° C., it was reheated to 90° C. to record the melting signature. The DSC trace is shown in FIG. 4. It can be seen that the highest melting peak has a peak maximum at about 73° C. and the peak starts at around 60° C. From the DSC reheating trace it can be seen that by 5° C. less than 60% of the lipid remains solid.

FIG. 5 shows the rheology of the gel forming. Evolution of G′ (▴) and G″ (▪) with time (sec), recorded at 1 Hz, for a 10% Dimodan HR gel in HOSFO, cooling down from 90° C. to 20° C. and stabilizing at 20° C., with a cooling at 2° C./min The strain amplitude was kept at 0.005% to ensure to be in the linear deformation regime. Geometry used was concentric cylinders. Two repeats are shown. It can be seen that after 10³ minutes when the gel forms, G′ is greater than G″ and G′ is greater than 10 Pa.

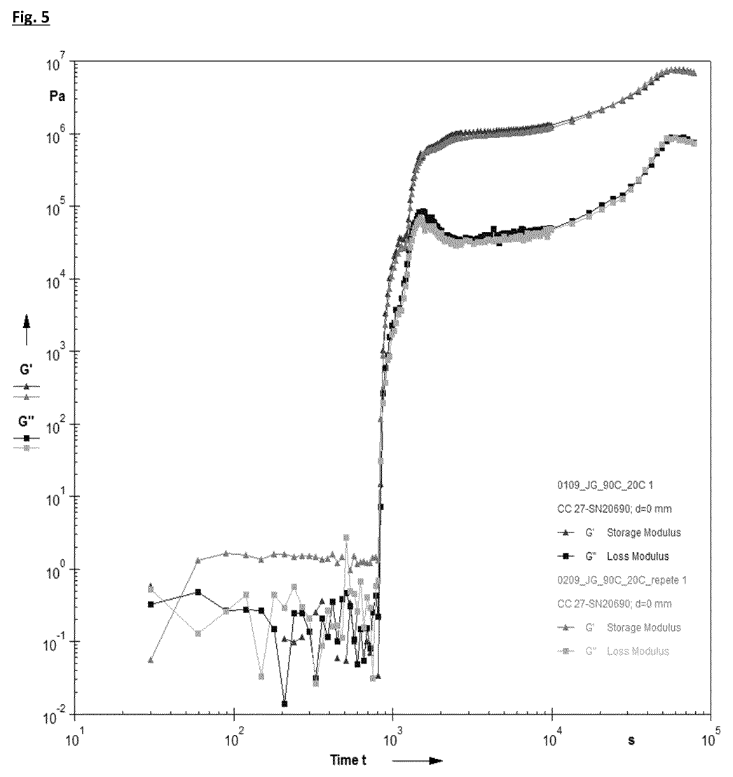

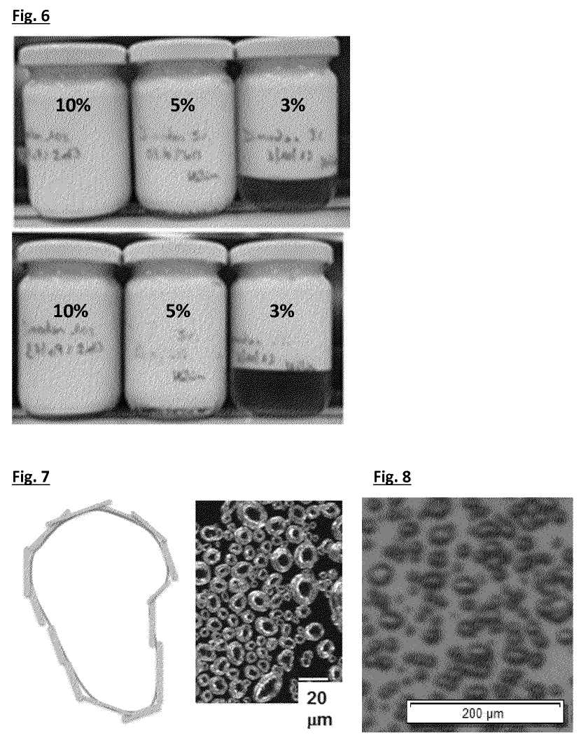

Mix preparation: 10%, 5% and 3% (w/w) mixtures of monoglyceride in HOSFO were heated to 90° C. until complete dissolution. 250 g of the heated solution was placed in a double-jacketed glass container. The mixture was cooled down over 20 hours by applying water at 4° C. to the jacket. The gel obtained was whipped at 4° C. in a Hobart kitchen mixer fitted with a balloon whisk at speed 15 min. The foams generated were stored at 20° C. and are pictured in FIG. 6. The top image shows the foams after 1 day and the bottom image is after 2 weeks. It can be seen that while the samples with 5% and 10% monoglyceride have good stability against drainage, the 3% monoglyceride foam showed some drainage.

### Example 5: Bubbles Coated by Crystals

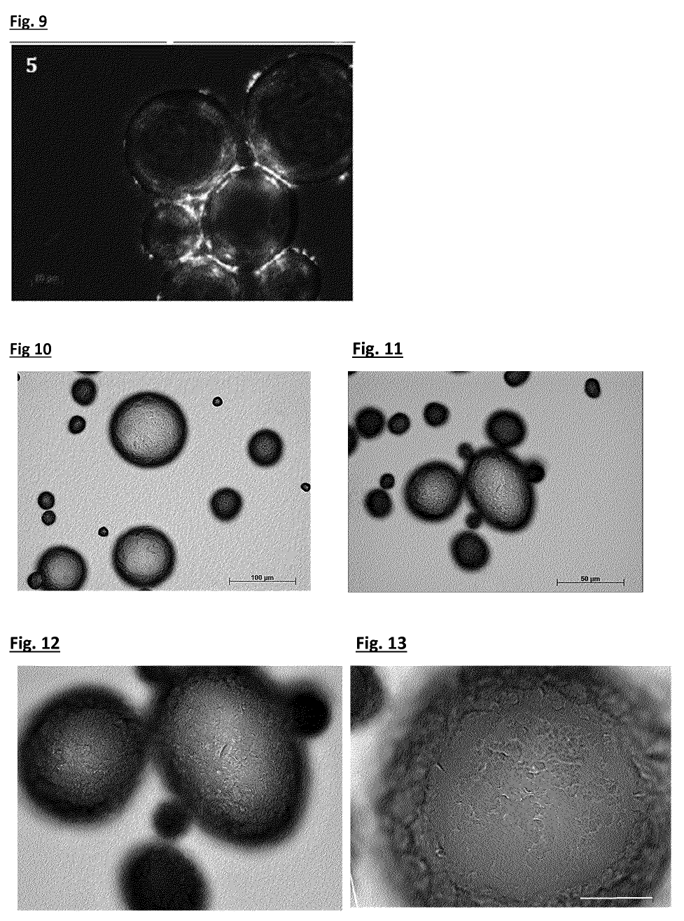

FIG. 7 (right-hand side) shows the dense layer of crystals absorbed at the surface of bubbles in a micrograph of a 10% monoglyceride in HOSFO foam, diluted by a factor of 4 with further HOSFO. The image illustrates the type of non-spherical shapes that are found under the microscope, whereby interfacial stabilization by surface adsorption of a dense layer of crystals creates the property of the non-relaxing shape (shown diagrammatically on the left-hand side of FIG. 7). FIG. 8 shows the cocoa butter/high oleic sunflower oil foam formed in trial 1.5 above, diluted with HOSFO. By diluting the foam with liquid oil (e.g. the same liquid oil used for foaming) the bulk rheological effects normally acting on bubble shape are suppressed, but the interfacial stabilization of the crystals around the bubbles can be observed by the fact that the bubble shapes do not relax. From microscopical observations of these foams, around 50% of bubbles were found to have a surface coverage at least 50% of the maximal surface coverage. Maximal surface coverage corresponds to a jammed structure of crystals adsorbed at a bubble's interface, or at the interface between two bubbles. The dense packing of crystals at bubble interfaces gives good stability. FIG. 9 shows crystals coating the interfaces between bubbles in a monoglyceride/HOSFO foam diluted with HOSFO.

### Example 6: Foams Stabilized by Monoglyceride Crystals—Adsorption Surface Density Estimation

### Gel Formation:

High oleic sunflower oil (HOSFO) and Dimodan HR monoglycerides were mixed at 80° C. until complete dissolution of the monoglycerides. The mixture was then removed from the hot plate and left to cool overnight at room temperature. The resulting mixture is then an oil gel with a paste-like consistency due to the network formation of the monoglyceride crystals.

### Foam Generation:

In a Hobart mixer with balloon whisk, speed 2, during 20 min at room temperature. During whipping, air is incorporated into the gel matrix and form bubbles coated by monoglyceride crystals that ensure long-term mechanical stability to the foam.

### Foam Characterization:

OR/porosity: The levels of aeration have been estimated by Over-Run (OR) or porosity (ϕ) measurements in standardized 3 cL plastic cups.

$$\% OR = \frac{{m}_{non aerated} - {m}_{aerated}}{{m}_{aerated}} \times 100$$

$$\% φ = \frac{OR}{OR + 100} \times 100$$

Bubble size: After dilution in HOSFO, a few drops of each aerated samples were placed onto a glass slide and then imaged using appropriate magnification and brightfield illumination using a Zeiss optical microscope. The diameters of more than 100 bubbles were then measured to estimate the Sauter mean diameter D[3;2].

$$D [ 3 ; 2 ] = \frac{\sum {D}_{i}^{3}}{\sum {D}_{i}^{2}}$$

Foam dilution and subnatant sampling:

Foams were diluted 5 times by HOSFO addition and gentle manual stirring until full homogenization. The samples were left at rest to cream 4 hours until phase separation occurred between an upper layer formed by bubble accumulation, due to buoyancy mismatch between air and the continuous oil phase, and a bottom phase formed by HOSFO and the remaining non-adsorbed monoglyceride crystals. The upper foam layers were then carefully removed with spoon and the subnatants were collected for analysis.

MAG titration:

Monoglyceride titrations were performed using gas chromatography. Limit of quantification: 0.05 g/100 g.

Foam characterization and analytical results:

3 foams have been prepared based on gels at different monoglyceride concentrations. Overruns, porosities and bubble size values are summarized in the table below.

| | Composition of the initial | OR | φ | D[3; 2] |
|---|---|---|---|---|
| Foam sample | gel | % | % | μm |
| 1 | 5% monoglyceride gel | 125 | 55.6 | 57.7 |
| 2 | 10% monoglyceride gel | 186 | 65.0 | 53.6 |
| 3 | 20% monoglyceride gel | 171 | 63.1 | 48.2 |

After dilution of the foams, 3 subnatant samples plus 1 pure HOSFO sample have been prepared and analysed by titration. The results of the monoglyceride (MAG) titration are shown below.

| | | Dilution | MAG concentration |
|---|---|---|---|
| Foam | Composition of | factor (X) | in diluted subnatant |
| sample | the initial gel | before sampling | g/100 g |
| 0 | pure HOSFO | 0 | 0.06 |
| 1 | 5% monoglyceride | 5 | 0.24 |
| 2 | 10% monoglyceride | 5 | 0.54 |
| 3 | 20% monoglyceride | 5 | 2.54 |

### Calculation Information:

Interfacial Area (S) Developed by a Foam:

$$S = \frac{6 φ V}{D}$$

V: volume of foam (m³)
ϕ: porosity
D: bubble Sauter diameter (m) as measured by optical microscopy/tomography

Concentration of Adsorbed Monoglyceride at Interface:

c_{ads}=cᵢₙᵢ−c_{non-ads}×X

C_{ads}: Monoglyceride concentration, relative to the oil phase, adsorbed at the air-oil interface of the bubbles
Cᵢₙᵢ: initial concentration of monoglyceride in the gel
C_{non-ads}: non-adsorbed crystal concentration as titrated from the diluted subnatant
X: dilution factor applied to the foam before collecting the subnatant

Adsorption Surface Density:

$$Γ = \frac{{c}_{ads} ( 1 - φ ) V}{S}$$

### Adsorption Surface Density Estimations:

| | Composition of the | OR | φ | D[3; 2] | Γ |
|---|---|---|---|---|---|
| Foam sample | initial gel | % | % | μm | mg · m⁻² |
| 1 | 5% monoglyceride | 125 | 55.6 | 57.7 | 234 |
| 2 | 10% monoglyceride | 186 | 65.0 | 53.6 | 303 |
| 3 | 20% monoglyceride | 171 | 63.1 | 48.2 | 306 |

### CONCLUSION

The adsorption surface density needed to stabilize a foam with monoglycerides is quite constant no matter the initial monoglyceride concentration in the gel.

From these values, coupled with the monoglyceride structure and size/shape we can theoretically estimate the surface coverage %. If we assume that monoglyceride crystals are pure and are forming a uniformly continuous and complete layer wrapping the bubbles (which is consistent with the micrographs) and if we approximate the monoglyceride crystal density at 0.9 g/cm³, the minimal layer thickness will be around 300 nm.

### Example 7: Foams Stabilized by Monoglyceride Crystals—Visualization of the Adsorbed Monoglyceride Crystals at Interface by Optical Microscopy

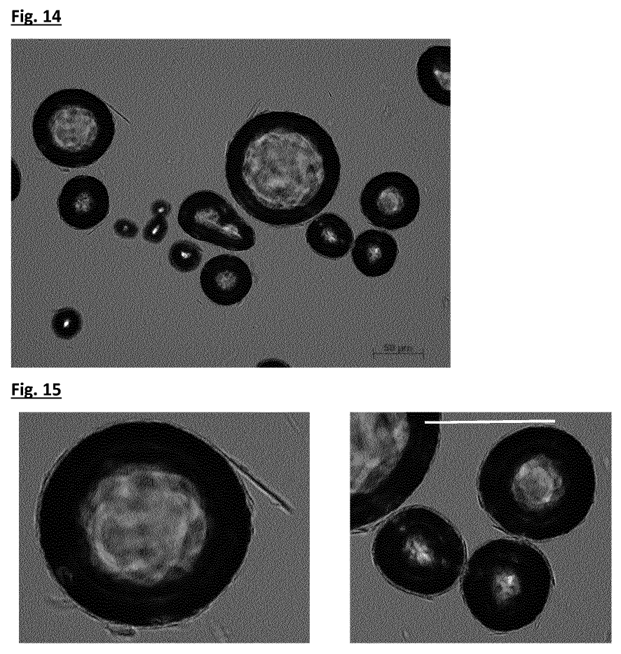

A 10% monoglyceride foam was prepared and imaged using an optical microscope as described in Example 6. Images of the bubble “poles” (FIGS. 10-13) clearly shows a complete layer of crystals adsorbed at the air/oil interface and forming a crust wrapping the bubbles. With such a high level of surface coverage it is immediately obvious after inspection by microscopy that at least 50% of the surface of the gas bubbles is occupied by crystals. Non spherical bubbles, as can be seen in FIGS. 11 and 12, are typical of a complete coverage of the bubble surface by jammed crystals arresting the spontaneous shape relaxation that should lead to a spherical shape. Images showing the bubble “equatorial plan” (FIGS. 14-15) show a thin layer of crystals adsorbed all around the bubbles, indicating a full and homogeneous surface coverage.

### Example 8: Foams Stabilized by Triglyceride Crystals—Visualization of the Adsorbed Triglyceride Crystals at Interface by Optical Microscopy

HOSFO and 10 wt % cocoa butter improver (CBI) were mixed at 60° C. until complete dissolution. The CBI (Illexao HS90-AAK) is based on fractionated shea butter and has a melting point of 43° C.±3° C. The HOSFO/CBI mixture was removed from the hot plate and left to cool overnight at 5° C. The mixture formed a gel with a paste-like consistency. Foam was generated in a Hobart mixer with balloon whisk, speed 2, for 20 min at 5° C. During whipping, air is incorporated into the gel matrix and forms bubbles coated by crystals that ensure long-term mechanical stability to the foam.

The samples were examined using optical microscopy. A few drops of the aerated material was placed onto a glass slide and then imaged using appropriate magnification and brightfield illumination using a Zeiss optical microscope. The images (FIGS. 16 and 17) clearly show a complete layer of crystals adsorbed at the air/oil interface and forming a crust wrapping the bubbles.

### Example 9: Laminated Pastry with Addition of a Foamed Liquid Oil

A reference laminated pastry was prepared. The reference laminated pastry was a puff pastry and contained 36 wt. % of butter (from cows' milk) before baking (pastry fat content was 39% on a dry basis). The butter was present in the dough (⅛) and as a lamination fat, layered on the dough (⅞). The butter used contained 82.2% fat and had a saturated fatty acid content of 54.9%.

### Recipe:

Lamination fat layer:

700 g butter was softened at 40° C. and mixed with 200 g flour in a Hobart kitchen mixer. The mixture was stored at 4° C. to harden.

Dough

100 g butter was softened at 40° C. and mixed with 800 g wheat flour, 400 g cold water and 25 g salt in a Hobart kitchen mixer to form a dough.

Lamination

The dough was rolled out into a square. Next the lamination fat was pounded with a rolling pin until it becomes pliable, formed into a flat piece and placed on the dough square. The combination was repeatedly folded onto itself and rolled out using a Rondo Seewer mechanical laminator. The lamination procedure was repeated three times, with the dough being chilled in a refrigerator in-between. The dough was rolled to 3 mm thickness, cut into shapes, allowed to warm to room temperature and then baked at 180° C. for 30 minutes.

A laminated pastry was prepared in the same way, but part of the butter in the lamination fat layer was replaced with a lipid foam.

The lipid foam was made as follows. 10 wt. % of CBI (Illexao HS90-AAK) was solubilized in high oleic sunflower oil at 60° C. The high oleic sunflower oil contained 8% saturated fatty acids, while the CBI contained approximately 61%. The mixture was left at rest at 4° C. overnight and formed a gel. The gel was then whipped at 4° C. for 1 hour using a kitchen mixer (Hobart, Switzerland) equipped with a balloon whisk. The obtained foam had an overrun of 243% (porosity 71%).

500 g butter was softened at 40° C. and mixed with 200 g flour in a Hobart kitchen mixer. The mixture was re-warmed to 40° C. and 100 g of lipid foam was mixed in, giving approximately the same volume of lamination fat as in the reference pastry. The mixture was stored at 4° C. to harden.

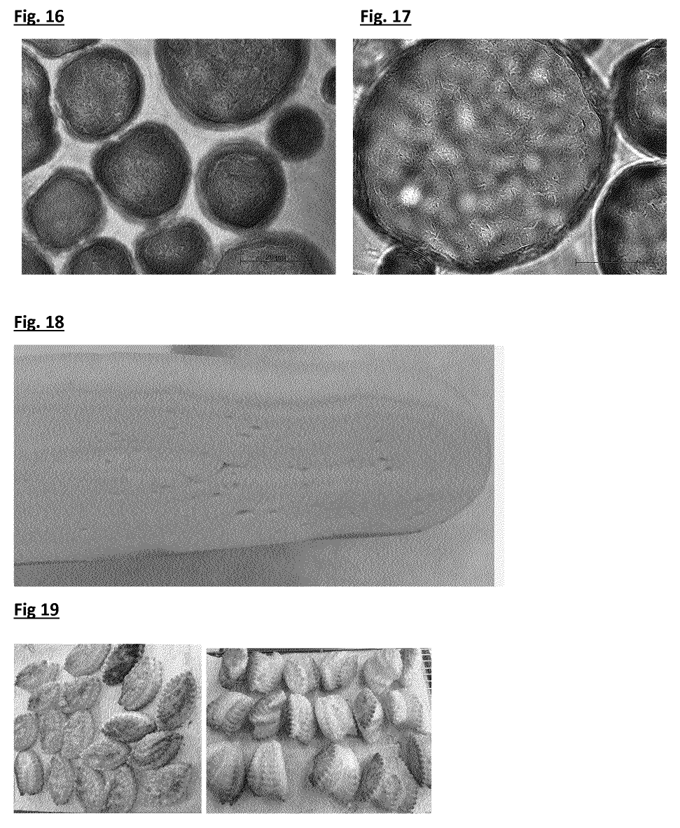

The pastry was otherwise prepared with the same quantities as for the reference. Layers could be observed in the pastry before final rolling to thickness (FIG. 18). The cooked pastry (FIG. 19 right) was indistinguishable from the reference (FIG. 19 left) by a taste panel. The total fat content of the laminated pastry made with a lipid foam was 36.6% fat (dry basis), a reduction of 6% from the reference. The saturated fatty acid content of the pastry on a dry basis was 21.27% compared to 26.1% for the reference. The saturated fatty acid content as a percentage of the total fat was 57.7% compared to 66.8% for the reference.

A further reduction in fat may be obtained by replacing a greater percentage of the butter with the lipid foam. Although no longer identical to the reference, such products were perceived as less “fatty” and preferred by some tasters.

For example, by repeating the above recipe with 300 g butter and 200 g of lipid foam in the lamination fat, the total fat content of the laminated pastry made with a lipid foam would be 34.0% fat (dry basis), a reduction of 13% from the reference. The saturated fatty acid content of the pastry on a dry basis would be 15.8% compared to 26.1% for the reference. The saturated fatty acid content as a percentage of the total fat would be 46.6% compared to 66.8% for the reference.

### Example 10: Laminated Shortening Pastry with Lipid Foam

A reference laminated pastry was prepared and compared to puff pastries made with a foamed lipid. The shortening fat was a palm-based fat having around 45% SFA content. The fat was about 7% solid at 40° C.

### Recipes (g)

| | Reference | Trial 1 | Trial 2 | Recipe 3 |
|---|---|---|---|---|
| Lamination | | | | |
| Shortening fat | 700 | 450 | 467 | 300 |
| Wheat flour | 200 | — | 133 | 200 |
| CBI | | | | 20 |
| HOSFO | | | | 180 |
| Dough | | | | |
| Wheat flour | 800 | 800 | 772 | 800 |
| Water | 400 | 400 | 400 | 400 |
| Shortening fat | 100 | 45 | 78 | 100 |
| Salt | 25 | 25 | 25 | 25 |
| Total (g) | 2225 | 1720 | 1875 | 2025 |
| % fat (cooked 7% moist.) | 41.0 | 35.0 | 34.5 | 34.5 |
| % SFA (cooked 7% moist.) | 18.4 | 15.8 | 15.5 | 11.8 |
| Fat reduction (%) | — | 14.5 | 15.7 | 15.7 |
| SFA reduction (%) | — | 14.5 | 15.7 | 35.5 |

For the reference the lamination material was prepared by fully melting the shortening and then mixing in the flour. The dough was prepared by mixing the water, flour and salt together and then cutting the fat into pieces before mixing it into the dough. All components were left in a cold-store overnight to harden before laminating as in example 9 to form 192 layers. The dough was rolled to 3 mm and cut into shapes with a pastry cutter. The top surface was brushed with egg to glaze and then the pastry was baked at 180° C. for 15 minutes. The final moisture was around 7%.

For Trial 1, the shortening fat was foamed before being used to laminate the pastry. The fat was fully melted and then cooled. Once at a scoop-able consistency it was whipped to a foam using a mixer fitted with a balloon whisk. The foam was used to laminate the pastry as for the reference.

For trial 2, the shortening fat was fully melted and then flour was mixed in before the mixture was cooled. The cooling was performed by periodically placing the bowl containing the mixture in an ice-water bath, mixing to ensure the flour was fully combined. Once the mixture formed at a scoop-able consistency it was it was whipped to a foam using a mixer fitted with a balloon whisk. The foam was used to laminate the pastry as for the reference.

The trial pastries expanded slightly less than the reference on baking, but were considered acceptable by a tasting panel, with trial 1 being equally liked to the reference.

A foamed shortening fat-based laminated pastry may also be obtained using an aerated oil (Recipe 3). The lipid foam is made as follows. 10 wt. % of CBI (Illexao HS90-AAK) is solubilized in high oleic sunflower oil (HOSFO) at 60° C. The high oleic sunflower oil contains 8% saturated fatty acids, while the CBI contains approximately 61%. The mixture is left at rest at 4° C. overnight to form a gel. The gel is then whipped at 4° C. for 1 hour using a kitchen mixer (Hobart, Switzerland) equipped with a balloon whisk.

300 g shortening fat is softened at 40° C. and mixed with 200 g flour. The mixture is re-warmed to 40° C. and 200 g of lipid foam is mixed in, giving approximately the same volume of lamination fat as in the reference pastry. The mixture is stored at 4° C. to harden. The overall SFA content of the lamination fat is 29%. The dough is prepared and the lamination is prepared as for the reference. Recipe 3 results in a 35.5% reduction of saturated fatty acids compared to the reference.

### Example 11: Filled Sandwich with Laminated Pastry

Filled sandwiches (also known as turnovers) were prepared using the same shortening fat as in Example 10.

| | | |
|---|---|---|
| | Reference | Trial |
| Ingredients | g | g |

Lamination

| | | |
|---|---|---|
| Shortening fat | 140 | 95 |
| Wheat flour | — | 27 |

Dough

| | | |
|---|---|---|
| Wheat flour | 1203 | 1203 |
| Water | 590 | 590 |
| Yeast | 11 | 11 |
| Sugar | 30 | 30 |
| Salt | 24 | 24 |
| Emulsifier | 3 | 3 |
| Total (g) | 2001 | 1983 |
| Cooked pastry fat (%) | 9.3 | 6.4 |
| Cooked pastry SFA (%) | 4.2 | 2.9 |
| Fat and SFA reduction (%) | | 32.1 |

The reference pastry was made by mixing all the dough ingredients. The dough was then rolled out and laminated with the shortening fat as in Example 9. The pastry was rolled to 3 mm thickness and cut into squares to form the top and bottom of a pastry sandwich. Filling was placed on each base pastry square and a second pastry square placed on top to enclose the filling. Liquid egg was used to seal the edges of the pastry. The sandwiches were baked at 180° C. for 15 minutes, the pastry having a cooked moisture content of around 7%.

For the trial recipe, the shortening fat was fully melted and then flour was mixed in before the mixture was cooled. The cooling was performed by periodically placing the bowl containing the mixture in an ice-water bath, mixing to ensure the flour was fully combined. Once the mixture formed at a scoop-able consistency it was it was whipped to a foam using a mixer fitted with a balloon whisk. The foam was used to laminate the pastry as for the un-foamed fat of the reference.

A tasting panel found the trial sandwich made with a lipid foam similar, but slightly preferable, to the reference.

1. Method for forming a laminated pastry wherein a lipid foam is laminated between layers of dough.

2. A method according to claim 1 wherein the lipid foam is formed by a method comprising the steps of:
providing a composition having a lipid content greater than 20 wt. %;
controlling the temperature of the composition such that the composition comprises glyceride crystals, has a solid lipid content after the temperature control between 0.1 and 80%; and
aerating the composition comprising glyceride crystals.

3. A method according to claim 2 wherein the composition having a lipid content greater than 20 wt. % is initially at a temperature at which it contains less than 0.1% solid lipid.

4. A method according to claim 1 comprising the steps
forming dough into a sheet;
applying a layer comprising the lipid foam to the dough sheet to form a combined sheet; and
folding and compressing the combined sheet at least twice to form a laminated pastry.

5. A method according to claim 1 comprising the steps
forming the lipid foam into small portions;
mixing the lipid foam portions with flour to form a heterogeneous mixture with portions of lipid foam dispersed in the flour;
adding water to the mixture to form a heterogeneous dough; and
compressing the heterogeneous dough to flatten the dispersed lipid foam portions into thin sheets and form a laminated pastry.

6. A method according to claim 1 wherein the laminated pastry is stored at a temperature of −40° C. to +10° C.

7. A method according to claim 1 wherein a filling is enclosed by the laminated pastry, the filling being selected from the group consisting of a sweet filing, a savoury filling, and combinations thereof.

8. A method according to claim 1 wherein the lipid foam has a continuous lipid phase and a porosity of between 1 and 80%, wherein, at a temperature at which the lipid phase has a solid lipid content between 0.1 and 80%, the foam comprises gas bubbles having at least 50% of their surface occupied by crystals, the crystals comprising a glyceride selected from the group consisting of monoglycerides, diglycerides, triglycerides, esters of monoglycerides, esters of diglycerides and combinations of these.

9. A method according to claim 8 wherein the crystals comprising a glyceride occupying the surface of the gas bubbles form layers having an average thickness below 5 μm.

10. A method according to claim 8 wherein the lipid phase comprises one or more fats and the crystals comprising glycerides occupying the surface of the gas bubbles comprise glycerides from all the one or more fats.

11. A method according to claim 8 wherein the lipid phase comprises one or more higher melting-point lipid ingredients and one or more lower melting-point lipid ingredients and wherein the melting-point of the lowest melting higher melting-point lipid ingredient is at least 10° C. above that of the melting point of the highest melting lower melting-point lipid ingredient and wherein the lower melting-point ingredients are present at a level of greater than 50 wt. % of the total lipid in the lipid phase.

12. A method according to claim 11 wherein the one or more higher melting-point lipid ingredients are selected from the group consisting of monoglycerides, diglycerides, esters of monoglycerides, esters of diglycerides, cocoa butter, shea butter, illipe butter, sal nut oil, mango kernel fat, palm kernel oil, palm oil, coconut oil, milk fat, high stearic sunflower oil and hydrogenation products, inter-esterification products, fractions and combinations of these; and the one or more lower melting-point lipid ingredients are selected from the group comprising sunflower oil, coconut oil, safflower oil, rapeseed oil, olive oil and combinations and fractions of these.

13. A method according to claim 1 wherein solid particles having a particle size of less than 500 μm are dispersed in the lipid foam.

14. A method according to claim 1 wherein the lipid foam has a saturated fatty acid content of less than 45 wt. %.

15. A laminated pastry having a saturated fatty acid content less than 45 wt. % of the total fatty acids in the pastry.
